(19) United States
(12) Patent Application Publication
(10) Pub. No.: US 2008/0043254 A1
(43) Pub. Date: Feb. 21, 2008

(54) Method for creating personalized promotional package and package resulting therefrom

(75) Inventor: Jesse D. Crum, St. Fort Scott, KS (US)

Correspondence Address: WARD/KRAFT, INC., 2401 COOPER STREET, P. O. BOX 938, FT. SCOTT, KS, 66701, US

(73) Assignee: Ward/Kraft

(21) Appl. No.: 11/504,742

(22) Filed: Aug. 15, 2006

(51) Int. Cl. G06K 15/02

(52) U.S. Cl. 358/1.2

(57) ABSTRACT

The present invention relates to a method for creating a package of at least two distinct personalized items and the resulting package that is produced from use of the method. The package produced by the utilization of the system and method of the present invention creates a plurality of highly personalized items by creating plural matching images, as well as potentially matching textual information, on a substrate by preferably only using a single piece of imaging equipment. The personalized items can use graphics obtained from stock or licensed images that may exist in a database or the graphics can be provided by the consumer or user of the system.

### CROSS-REFERENCES TO RELATED APPLICATIONS

None.

### FIELD OF THE INVENTION

The present invention relates to a specialty manufacturing system and method for creating personalized promotional packages that contain a number of high resolution, high quality printed items. The package produced in accordance with the present invention contains a printed poster and at least one additional personalized items selected from a group including presentation folders, sheets of pressure sensitive products, cards, tags, magnets and combinations thereof. The user can either select various graphics for imaging on a substrate or supply graphics that may originate with the user. The substrate is then separated to form a plurality of blanks which form the blanks for the personalized items that have been requested by the consumer. Each of the items produced by the system and method contains matching personalized graphics and may also contain matching personalized textual information, so as to be able to allow the recipient of such items to recall the event.

### BACKGROUND OF THE INVENTION

There are currently a plethora of office products, business form constructions and other stationery items that are available in the market today and yet with this inordinately large selection of offerings and permutations, there remains a continuing need to develop new products due to changes in technology, societal trends, diversification and new information handling needs of businesses and consumers alike.

The market for printed materials is changing and becoming significantly more sophisticated. Conventional business forms manufacturers have normally produced product runs that range in the hundreds of thousands to millions or even tens of millions of pieces for a single order. As such, the equipment that is used to produce product at these levels or quantities is then set up to handle only large manufacturing runs. The apparatus used in this type of fulfillment will normally only operate efficiently in this higher range of production quantities and often cannot be reconfigured as the apparatus has been constructed in such a specific manner so as to be able to optimize production efficiencies of these larger runs. Thus, even if a manufacturer wished to pursue smaller runs, orders sizes or pursue small market niches, the manufacturer is faced with the dilemma of making new capital expenditures to purchase equipment that specializes in this type of application. This along with the possibility of having to retrain existing personnel or hire and train new employees to generate this type of production activity places additional constraints on the decision making process.

Traditional manufacturers of business communications, such as business forms and labels, may also be limited in the type of jobs that a manufacturer will accept. These additional factors may include the size of the job, or more particularly the order quantity or value of the order. That is, due to cost factors, a customer will not place an order with a manufacturer for a small to medium quantity of pieces or if different substrates are required as the set up or make ready of the job makes the order cost prohibitive, even assuming that the manufacturer would accept the order if a particular price could be obtained to justify production.

A still further drawback of trying to migrate to smaller or individualized customer applications relates to quality of the pieces that need to be generated. With the focus of the market shifting to smaller runs and the level of personalization increasing, the end user is now demanding a greater image quality than that typically associated with conventionally printed products.

It is believed that one of the reasons for such far reaching changes is that end users want more from each piece that is produced rather than relying on the quantity of pieces to generate the desired result. In addition, marketers want to make a greater impact at every turn in the retail chain to try and maximize the chances for purchases of a particular product being offered.

With the change in focus to quality as opposed to quantity there are a number of products or applications that to date are still out of reach of conventional manufacturers in that certain items simply cannot be handled by printing equipment and forms processing apparatus. That is, where a small order for multiple items is presented to a manufacturer, the traditional manufacturer would have to set up multiple pieces of fulfillment equipment as opposed to being able to a multipart order through a single or very apparatus.

Flexographic technology is commonly used today in the rendering of film packaging, marketing communications and normally will utilize a series of plates and one or more stations, containing inks; to apply colored images to the web as the web traverses the press. Through improvements in ink qualities and other modifications and enhancements in the technology, the image quality in flexographic presses and resulting products has improved to about 150 lines per inch. In addition, flexographic printing presses are also limited by the thickness of the substrates that can be effectively handled and processed by the equipment.

Typically, for a point of reference, screens that have rulings of about 60 to 100 lines per inch are normally used to make halftone printed images for newspapers. Screens with about 120 to 150 lines per inch are commonly used today to produce images for magazines and commercial printing. Such screens are regularly produced by electronic dot generation.

Electronic dot generation is normally performed by computers that use unique screening algorithms in cooperation with electronic scanners and image setters to produce halftone images that are to be subsequently used to render an image. The pixels of digitized images are first assembled into dots that are then used to form shapes, sizes, rulings, etc. which create the ultimate image produced on the substrate.

While use of such conventional technology such as flexography is desirable in the printing of films and other relatively materials due to the economies that can be achieved when compared with other types of printing processes, such as lithography, there are a number of drawbacks in utilizing this process for certain applications. Initially, the quality is limited, despite improvements in the technology to about 150 lines per inch. This can make some complicated graphics appear “grainy”. Other images such as those that use flesh tones or deep or rich colors, may look faded or “washed out”. The effects of this level of image resolution can detract from the product appearance which may diminish the value of the technology and the products produced. With the increasing sophistication of consumers and their expectations, such effects may be undesirable to potential end users. In addition, such conventional printing technology cannot be readily adapted to produce small quantities of products in order to meet the growing niche market of highly personalized items and memorabilia.

There are currently available various offerings in the market place that offer a consumers such items as posters, stationery and other similar products. However, there does not appear to be a solution available in which a consumer may acquire various items in a number of distinct formats such as a package that includes a poster and presentation folders and other individualized pieces. No system seems to be available which provides the ability to personalize each item and have each item reflect the same graphical depictions selected by the user.

What is need therefore is an efficient system by which to create a number of distinct formats of personalized printed promotional items with matching graphical images and textual information that can be provided in a convenient package.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Surprisingly, it has been discovered that there is no available personalized offering that combines selected graphics and textual images and matches the graphics and images on multiple distinct product formats to create individualized products such as a poster and at least one other personalized product.

In one exemplary embodiment, a personalized promotional package containing at least two distinct formats is described and includes a shipping package, a personalized poster with the personalized poster being provided with high resolution graphics. At least one additional personalized printed product is included in the package. The personalized printed product is selected from a group including at least presentation folders, pressure sensitive labels, cards, magnetic products and combinations thereof. The personalized printed product that is provided in the package includes graphical depictions that match the graphics contained on the personalized poster.

In yet another exemplary embodiment, a method of producing a personalized promotional package containing at least two personalized items is described and includes the steps of initially advertising a service for personalized printed products and then soliciting orders for personalized printed products. The personalized printed products include at least personalized posters and presentation folders, each of which is provided in a distinct format from the other. At least one image is selected for use in preparing an order and then the order is entered for multiple distinct formatted items with the order including at least one personalized poster and at least one presentation folder. Next, a graphics file is prepared for the order and at least one substrate that is capable of receiving graphical and textual information is provided. The order is then printed on a single piece of equipment at a resolution of greater than about 150 lines per inch and then the order is delivered to a requestor.

In a still further exemplary embodiment of the present invention, a personalized package containing promotional items that has distinct formats produced in accordance with the following steps is described and includes initially soliciting orders for distinct personalized printed products. The personalized products include at least one poster, presentation folder and tag with each of the personalized products containing matching printing. Then at least one order is obtained for the personalized printed products and an image is selected for use in connection with the personalized products. At least one substrate is use in receiving separate image depictions in areas of the substrate for each of the personalized products. Then an image is rendered in each of the areas on a single piece of imaging equipment. Next, the substrate is severed to produce blanks for use in creating distinct product formats for each of the personalized products. The personalized products are packaged in a shipping container and then delivered to a customer.

In each of the foregoing embodiments, additional features are possible. The substrate that is used in connection with capturing the images that are selected is preferably severed into multiple blanks that are then used to form each of the respective personalized products. The individual blanks may undergo further processing such as folding, having a layer of adhesive applied such as may be the case in forming pressure sensitive products, or be laminated to a magnetic or other material to form a particular product such as a magnet, card, key tag, etc.

Users of the presently described system may also select images from a database of content that may have been obtained from a licensed source, or other professional sources, or alternatively, a user can supply his or her own images for use in the production of the package. In addition, the user may also add personalized textual information in order to further customize and individualize the package and products that have been ordered.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a substrate that is printed in accordance with the present invention and illustrates a number of distinct format products each of which has been printed with matching graphical and textual information;

FIG. 2 shows a package containing a number of printed personalized promotional items;

FIG. 3 illustrates a block diagram that is used in carrying out the method of preparing the personalized products in connection with the present invention;

FIG. 4 presents a schematic of a system used in practicing the presently described invention;

FIG. 5 presents a series of distinct blanks for a number of different personalized product formats; and

FIG. 6 depicts a cross section of a personalized product that may be provided in connection with the package produced in connection with the present invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

The term “personalized information” refers to information that is printed or imaged onto a substrate or document which is generally variable or unique and which may change from laminate to laminate so as to create a customized message or communication for each recipient. Examples of personalized information may include names, addresses, descriptions, plans, coding, numbering, promotional text, recipes based on contents, etc. that may have been acquired from the intended recipient through surveys, questionnaires or answers given to various inquiries generated in response to a request for goods or services.

The term “static or fixed” information refers to printed or imaged information that generally does not change from laminate to laminate and may include a general description or body of information about particular products, services, places, etc. that may be of interest to the intended recipient and represents a standard message that the manufacturing or supplier wishes to convey to an end user or customer of the offering.

Printable substrates that may be used in connection with practicing the present invention are normally purchased in accordance with its weight per unit area. The area is normally that of a 500 sheet ream cut to a specified sized (“ream size”). For example, if a certain grade of paper has a specified ream size of 17×22 inches, the actual weight of 500 sheets in that size is the basis weight. A sheet with a 20 pound basis weight may be identified as 20-lb. or 20# and is customarily used in desktop printers and office use. Heavier bonds such as vellum may range from 60 to 80 pounds, Bristol board from 90 to 100 bounds and tag stock for example from 80 to 110 pounds and higher.

Examples of image generating or high quality printing devices that are suitable for use in practicing the invention include high resolution imaging devices such as Indigo®, available from Hewlett Packard of Palo Alto, Calif. or Karat available from KBA of Williston, Vt. Ideally, the present invention seeks to provide images on a substrate that has a resolution quality of about 150 or more lines per inch and preferably more than 300 lines per inch, which is approximately equal to about 2500 to 3500 dots per inch (“DPI”) in order to create a high quality image that is intended to be aesthetically appealing to the consumer. Other imaging equipment may of course be used depending on the sheet or web size that the equipment can efficiently handle.

The system can be used to produce highly personalized textual information in addition to generating high quality, high resolution graphical images. Such textual information may include details relating to the graphics to be generated, such as the name of the athlete, the date of a game, time of a score or other event, final score of the game, number of the player and the like. This information can then be printed on the poster, the presentation folder, key tags, wallet cards and the like so that various memorabilia is created in recognition of the event. The system and method can obviously be used with other non-sporting events that one desires to have memorialized, such as family reunions, social gatherings, business milestones, personal events such as births of a child, graduation ceremonies, public and award recognitions and the like. In selecting one of these events for remembrance, the user can supply his or her own information or can use elements of the system for assisting the user in creating the appropriate information for the personalized pieces.

The images or graphics that may be used in the preparation of the invention can come from a variety of sources. For example, the graphical content can be provided by the manufacturer and may be obtained from a professional source, such as a photographer, sports association or the like for which the content for the specific application has been licensed, or alternatively the graphical images may be supplied by the consumer or user of the system. Images that may be used in fulfillment of an order may of course be selected from scenery, places, events, people, animals, inanimate objects, artistic representations and reproductions and such other images as may be aesthetically pleasing to a user. The system can also be used to create fictitious displays, and overlays such as superimposing a personal image of a family member at an event, for example a family athlete at a well recognized sporting event, scaling a mountain or taming wild animals and the like.

Posters that may be produced in accordance with the present invention will preferably have a length ranging from about eighteen inches to about seventy two inches and a width ranging from about twelve inches to about thirty six inches.

Presentation folders will generally have overall dimensions running about twelve inches by eighteen inches (12″×18″), having two panels with a pocket appearing in the lower quadrant of each panel. The pockets formed from the present invention will have a height of around 4″ to 4¼″ and a width of up to 9 inches.

Cards, including plastic and laminated cards and tags, come in a variety of sizes and shapes depending on the particular needs of the issuer or end user. Wallet sized cards have become fairly common place and due to the popularity of such cards, the products have been used for identification cards, credit card, key cards, hospitality, gift cards and a host of other applications. Wallet sized cards have a size of about 3⅜ inches wide to 2⅛ inches in length.

Magnets produced in accordance with the present invention, may be provided in any sort of shape or configuration that is requested by the customer. In forming a magnetic product, the substrate may for example after printing be applied to a sheet or web of magnetic material and then laminated together such as by the use of a pressure sensitive adhesive. The magnetic material is then die cut to produce the final requested shape.

One of the most important things with respect to new product innovations is the need to effectively market, advertise and communicate the new product to potential customers and end users of the product. Such marketing typically includes the creation of marketing collateral or promotional materials which are associated with the features of the package of the present invention and then distributing the package in connection with those promotional and/or marketing collateral and distributing the package along with the to end users and customers. Additional advertising may be provided through solicitation of traditional channels such as trade shows, e-mail, facsimile distributions and the like.

Marketing collateral and promotional materials as used herein includes the use of scripted or prepared material that are distributed through audio and visual communication mediums, over a global communication network, through printed mediums such as newspapers, trade publications, magazines, fliers, handouts and the like.

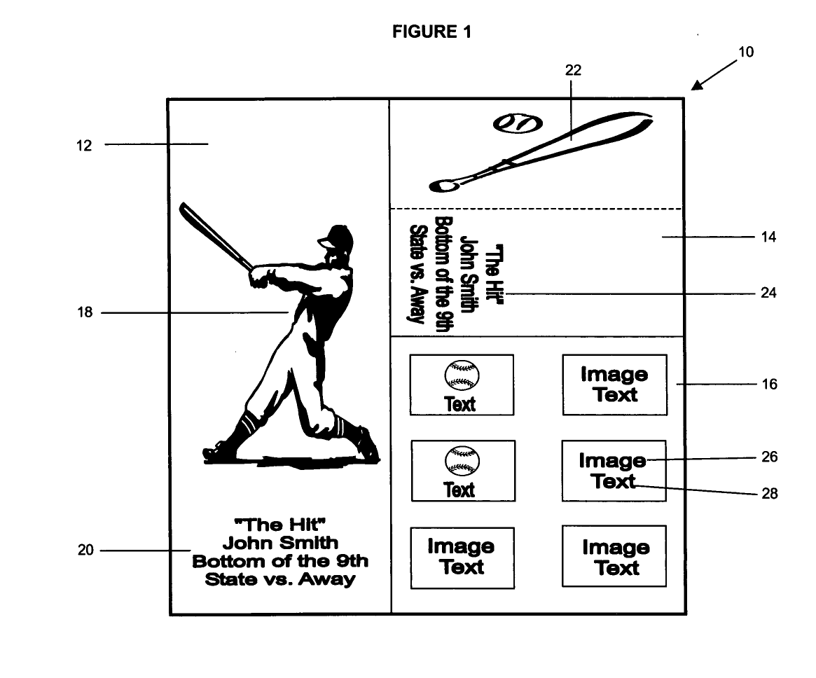

Reference is now directed to FIG. 1, which provides an illustration of a substrate 10 that is divided into a number of predetermined areas based on the types of personalized products that are to be produced. In connection with the presently described FIG. 1, the substrate 10 is divided into three separate areas 12, 14 and 16, with each of the areas representing discrete product formats.

Area 12 for example is defined as a poster portion of the substrate 10. The poster area 12 is provided with imaging 18 in the present instance a depiction of an athlete is provided. In this arrangement, the image 18 may have been provided by a consumer as it represents a personally obtained image. The image may be transmitted to the manufacture via a global communications network or other digital file such as a compact disc, digital cameral memory card or the like. The poster area 12 is also provided with personalized textual information 20 which may also be provided by the consumer ordering the particular product. In this example, the imaging 20 details the event that is depicted in the image thereby making the image more individualized for the particular consumer.

Area 14 of FIG. 1 provides a presentation folder format in which a matching image 22 has been provided to that of image 18 cited in the poster area 12. In addition, matching textual information is also provided at 24 which again is intended to match the indicia provided at 20. The system and method of the present invention may allow for additional or different information to be placed on the different formats areas of the substrate.

Area 16 shown in FIG. 1, provides for a third different format that is provided on the substrate. The area 16 is used to create for example a number of different items such as wallet cards, key cards, face blanks for magnets or pressure sensitive labels and other piece applications. As with the other areas, each of the individual pieces will preferably also be provided with graphics 26 and textual information 28 that will again match the images and/or graphics and textual information provided in each of sections 12 and 14. By creating a substrate having multiple formats for personalized products, a consumer is not limited in the types of products that can be order in connection with any particular session.

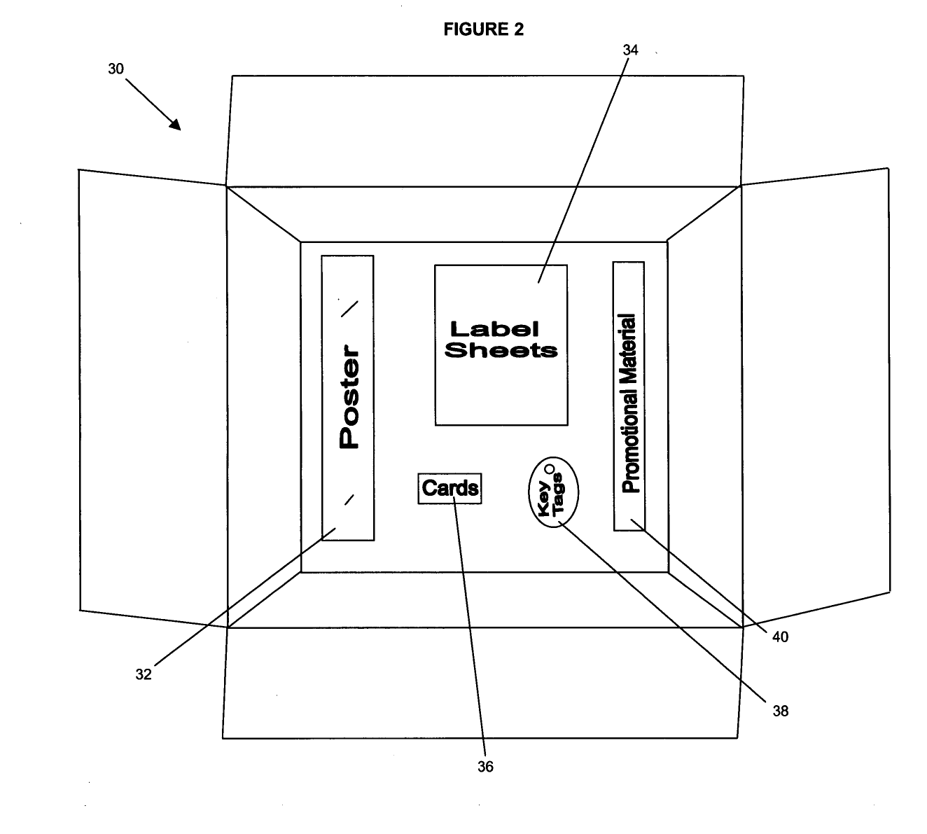

FIG. 2 shows a package that is produced in accordance with the present invention. The package 30 may be any suitable shipping package, such as a carton, box, envelope or the like. As shown by the FIG. 2, the package 30 contains a number of items in a packaged configuration, including a rolled poster 32, a number of pressure sensitive label sheets 34, wallet cards 36, key tags 38 and promotional material 40. The illustration provided by FIG. 2 presents one exemplary embodiment of the contents that may be provided in a package and the package may contain additional items, plural types of the same items or completely different items depending on the particular order format of the consumer.

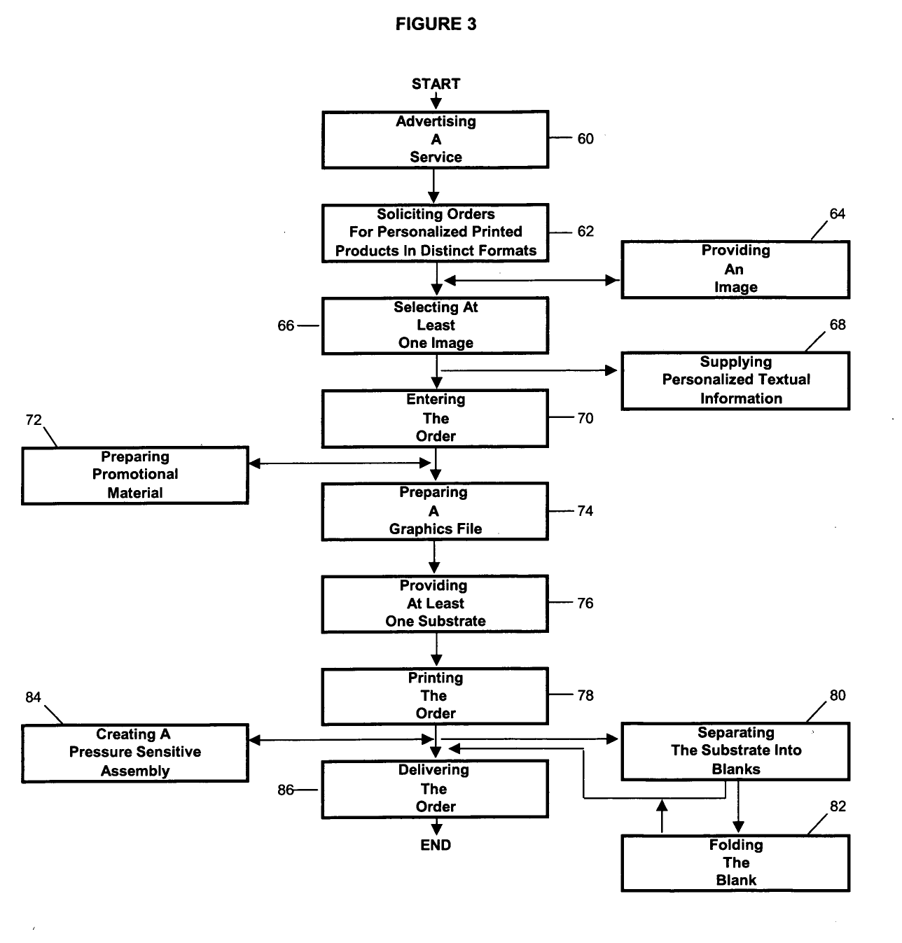

FIG. 3 provides a block diagram of an exemplary method that is used in carrying out the preparation of the package of the present invention. The process is started for example by advertising the availability of the service at step 60. Orders for the system and method are solicited at step 62, such as by creating promotional materials that may appear in e-mail, facsimiles, direct mail and other applications. A user selecting to use the service may opt to provide an image that the user created at step 64 or alternatively, the user may select an image from a database that contains a number of images that may have been obtained from a professional source or licensed from an organization at step 66.

The user may then next opt to supply personal textual information at step 68. The system utilized in performing the method may also provide fixed or static information or fields which the user may utilize in connection with populating the textual portions of the substrate.

Once the selection of the image and inputting of the textual information, if any, has been competed the order is entered at step 70. The order may be submitted over a global communications network, via mail, facsimile or other suitable means. At this point, the manufacturer having received information from the consumer may prepare additional promotional materials such as discounts against future orders, and other offers at step 72. This promotional material will preferably be added to the package when the package is completed and readied for delivery to the user at a later step.

Next, a graphical image or digital file is created at step 74 by using any known software platforms. Once the digital files have been created, at least one printable substrate is provided at step 76. The number of substrates that are made available at step 76 will depend on the quantity of personalized products that are being ordered by the consumer.

The order is then printed at step 78 by using a high quality, high resolution imaging device. The imaging device will preferably generate images at a resolution of greater than about 150 lines per inch and may either be sheet fed or web fed depending upon the substrate that the manufacture selects for processing of the order.

Once the substrate is printed, the individual blanks may be separated from the substrate at step 80. Each of the blanks will correspond to the type of product that is being produced in connection with the order. For example, if a presentation folder is one of the blanks, then at step 82 the blank is folded into a presentation folder such as by folding portions over to create the pockets of a conventional folder. If other products are being created such as a magnet or pressure sensitive assembly, then at step 84 for example a pattern of pressure sensitive adhesive is applied to the opposite side of the blank from the side on which the image has been applied.

Once the blanks have been completed and formed into the final product configurations as requested by the consumer, the order is then delivered to the end user at step 86. Delivery may occur through use of a courier service, USPS other conventional means. The process then ends and may be restarted for another customer.

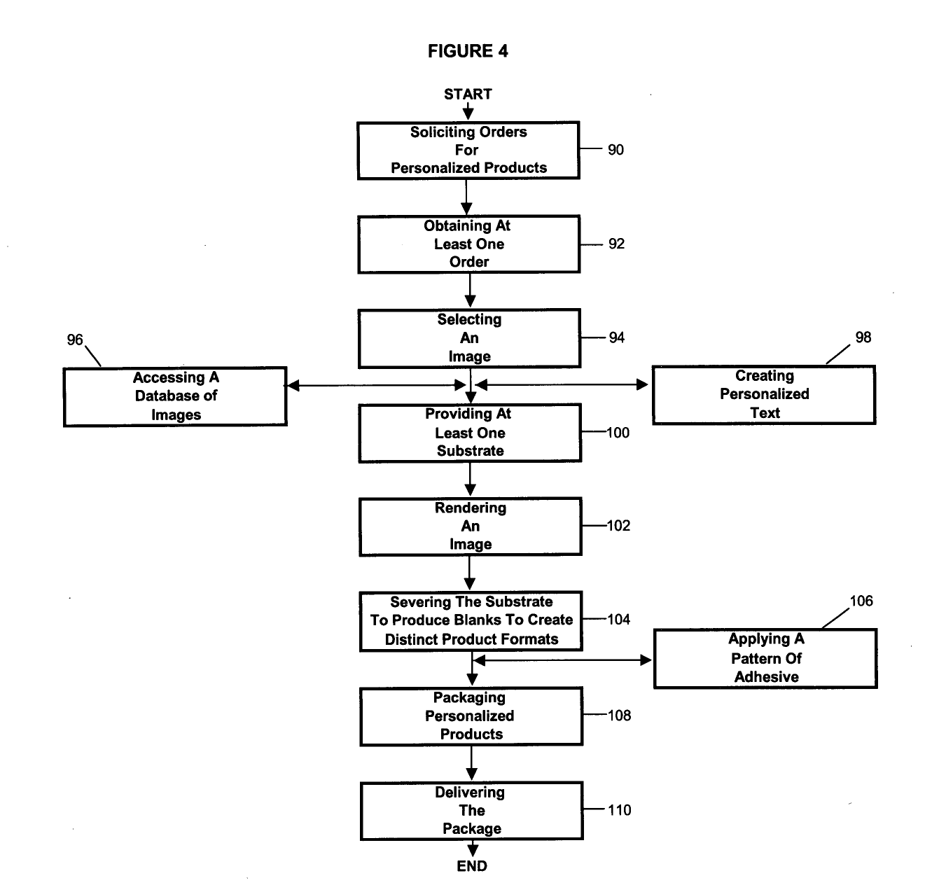

A further exemplary process for producing a package is depicted in FIG. 4 in which after the process is started, orders for personalized printed products are solicited at step 90. Once an order is obtained at step 92 an image can be selected at step 94. The image can be one that is provided by a consumer of the product and services or alternatively, the image can be obtained from a database where a collection of images have been assembled at step 96.

Next, the user after having either selected an image, may then provide personalized textual information at step 98. Personalized information may be combined with static information at this particular step. For example, if the image selected is from a well known sporting event, the static or fixed text may be details relating to the actual event, such as the date, place, score and the like and the personalized information may be the name for whom the package is being prepared, plus other information such as a greeting for the package and from whom the package is provided.

After the details are finalized for the order, the manufacture will select a substrate at step 100 based upon the parameters of the equipment that is to be utilized and the details of the particular order. The substrate will typically be of a heavier stock of material and one that can support and possibly highlight the printing that will be applied. For example, if a combination of a poster and a presentation folder are to be prepared, then the stock may be about eighty pound stock.

The image is then produced at step 102, and preferably at a resolution level of greater than about 150 lines per inch. Once the substrate is printed, the substrate is severed at step 104 to produce individual blanks that pertain to the types of products that are to appear in the personalized package. For example, if the order is for a poster, presentation folder and card blanks, then three separate blanks will be produced with each sized and configured to facilitate the processing and final assembly of the blanks into the finished products.

If blanks are created for example cards, magnets, labels and the like, then at step 106, for instance in preparing a sheet of pressure sensitive labels, then a pattern of pressure sensitive adhesive is applied to at least a portion of the blank at step 106 so as to be able to complete the final assembly of the ordered product.

After the final assembly of each of the products has been completed, then the products are packaged at step 108. The packaging container that is use will preferably be a suitable shipping container, such as a box so as to prevent damage of the contents during shipping. Once the package is complete, then the package is prepared for delivery at step 110 and the process is completed. In the event that the package is damaged during shipping or the order is incomplete, the package will also include a return shipping label so that the products or a portion of the products may be conveniently returned to the manufacturer for credit or replacement.

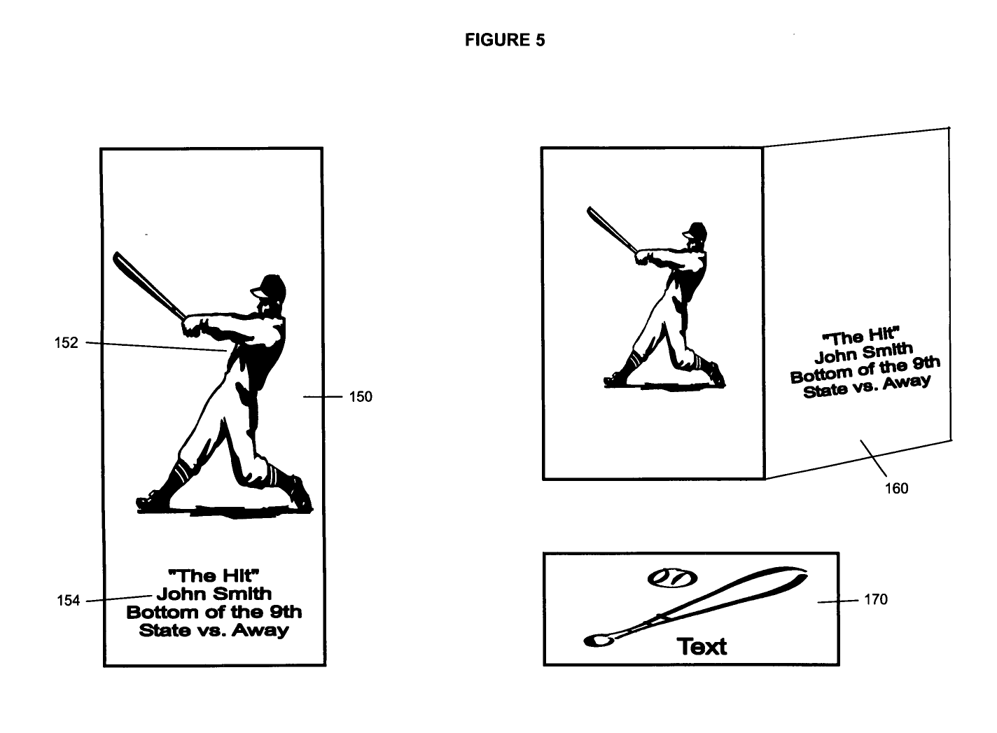

FIG. 5 is used to illustrate the substrate after it has been cut into individual blanks to meet the needs of the different product formats that may have been ordered by the customer. As shown, FIG. 5 depicts three separate blanks 150, 160 and 170, with blank 150 forming the personalized poster, blank 160 the presentation folder and blank 170 forming a card blank. Each of the blanks is provided with matching graphics and textual information. For example, blank 150 includes an image 152 of an athlete and personalized textual information at 154 describing the particular event shown in the image.

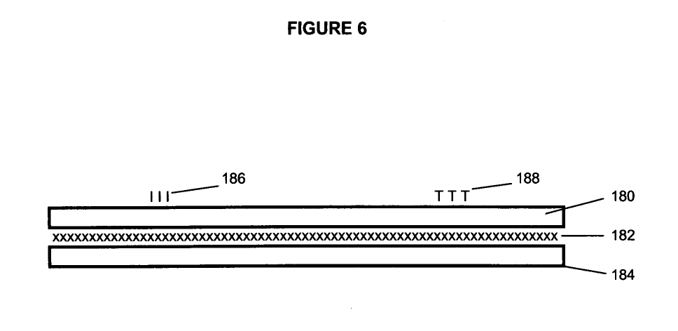

FIG. 6 is presented to show a cross section of an alternative format of one of the product templates that may be prepared for inclusion in the package of the invention. The substrate 180 is coated on one side with a pressure sensitive adhesive 182 to which for example a release liner 184 may be applied when the product configuration is a label. If alternatively, the blank were to be used in creating a magnetic assembly, then layer 184 would be a magnetic material. The substrate 180 is also shown with imaging 186 designated by “III” in the drawing and textual information 188 which has been designated by reference to numeral 188.

As can be seen from drawings and the related description of the present invention provides a unique method for producing a package of highly individual personalized items that are produced using an imaging device that generates the resolution at a level of greater than about 150 lines per inch. The package produced through the described method provides the recipient with a number of distinct product possibilities including posters, presentation folders, cards, magnets, pressure sensitive labels, key tags and other formats. By providing a variety of different personalized format, the recipient may then keep the memorabilia with him or her and is not simply limited to looking at a single format of the remembrance item.

It will thus be seen according to the present invention a highly advantageous system and method for producing a package containing high resolution personalized printed items has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A personalized promotional package containing at least two distinct formats, comprising;
a shipping package;
a personalized poster, said personalized poster provided with high resolution graphics;
at least one additional personalized printed product included in said package, said personalized printed product is selected from a group including at least presentation folders, pressure sensitive labels, cards, magnetic products and combinations thereof; and
wherein said at least one additional personalized printed product including graphical depictions matching said graphics contained on said personalized poster.

2. A personalized promotional package as recited in claim 1, wherein said graphics are printed at a resolution of greater than about 150 lines per inch.

3. A personalized promotional package as recited in claim 1, wherein said personalized presentation folder, said at least one additional personalized product and said poster are each printed with matching personalized textual information.

4. A personalized promotional package as recited in claim 1, wherein said package further includes at least one laminated key card product.

5. A personalized promotional package as recited in claim 1, wherein said package further includes at promotional offerings, coupons and marketing collateral.

6. A personalized promotional package as recited in claim 1, wherein said package further includes at least one greeting card product having matching graphical depictions.

7. A personalized promotional package as recited in claim 1, wherein said package further includes a return shipping label for returning products.

8. A method of producing a personalized promotional package containing at least two personalized items, comprising the steps of;
advertising a service for personalized printed products;
soliciting orders for personalized printed products, said personalized printed products including at least personalized posters and presentation folders, each of which is provided in a distinct format;
selecting at least one image for use in preparing an order;
entering said order for multiple distinct formatted items with said order including at least one personalized poster and at least one presentation folder;
preparing a graphics file for said order;
providing at least one substrate capable of receiving graphical and textual information;
printing said order on a single piece of equipment at a resolution of greater than about 150 lines per inch; and
delivering said order to a requestor.

9. A method as recited in claim 8, including a further step of supplying personalized textual information on each of said personalized poster and presentation folder prior to the step of preparing graphics for said order.

10. A method as recited in claim 8, including a further step of separating said substrate into blanks for at least one poster and at least one presentation folder and at least one other portion after the step of printing said order.

11. A method as recited in claim 10, including a further step of folding said blank into said presentation folder after the step of separating said substrate into blanks for said poster and presentation folder.

12. A method as recited in claim 10, including a further step of creating a pressure sensitive label assembly from said one other portion after the step of separating said substrate.

13. A method as recited in claim 8, including a further step of preparing promotional material for inclusion in said package prior to the step of delivering said order to a requester.

14. A method as recited in claim 8, wherein the step of selecting an image includes a step of providing a previously prepared image or selecting an image from a group of assembled images.

15. A personalized package containing promotional items having distinct formats produced in accordance with the following steps;
soliciting orders for distinct personalized printed products, said personalized products including at least one poster, presentation folder and tag with each of said personalized products containing matching printing;
obtaining at least one order for said personalized printed products;
selecting an image for use in connection with said personalized products;
providing at least one substrate for use in receiving separate image depictions in areas of said substrate for each of said personalized products;
rendering an image in each of said areas on a single piece of imaging equipment;
severing said substrate to produce blanks for use in creating distinct product formats for each of said personalized products;
packaging said personalized products in a shipping container; and
delivering said package to a customer.

16. A personalized package as recited in claim 15, including an additional step of creating personalized textual information on each of said personalized products after the step of selecting an image.

17. A personalized package as recited in claim 15, wherein said package further includes at least one personalized magnetic piece and at least one pressure sensitive assembly.

18. A personalized package as recited in claim 15, wherein said image is produced at a resolution of at least about 150 lines per inch.

19. A personalized package as recited in claim 15, wherein said step of selecting an image is performed by accessing a database containing a number of predetermined images.

20. A personalized package as recited in claim 15, including an additional step of applying a pattern of adhesive to a portion of said substrate to create a pressure sensitive tag prior to the step of packaging.
